(19) United States
(12) Patent Application Publication
(10) Pub. No.: US 2021/0144088 A1
(43) Pub. Date: May 13, 2021

(54) SYSTEMS AND METHODS FOR FAST CONNECTIVITY RECOVERY IN TREE-BASED DISTANCE-VECTOR ROUTING PROTOCOLS

(71) Applicants: Pinchas ZIV, Rosh Haain (IL); Reuven COHEN, Rosh Haain (IL); Eran BEN-SHMUEL, Rosh Haain (IL); Alexander BILCHINSKY, Rosh Haain (IL)

(72) Inventors: Pinchas ZIV, Rosh Haain (IL); Reuven COHEN, Rosh Haain (IL); Eran BEN-SHMUEL, Rosh Haain (IL); Alexander BILCHINSKY, Rosh Haain (IL)

(21) Appl. No.: 17/095,403

(22) Filed: Nov. 11, 2020

Related U.S. Application Data
(60) Provisional application No. 62/933,627, filed on Nov. 11, 2019.

(51) Int. Cl. H04L 12/753; H04L 12/751; H04L 12/703; H04W 84/18

(52) U.S. Cl. CPC H04L 45/48; H04W 84/18; H04L 45/28; H04L 45/02

(57) ABSTRACT

Approaches for recovering a connectivity failure in a network having multiple cells, each (i) supporting communication among multiple transceiver nodes, (ii) being capable of receiving and transmitting a packet and (iii) being associated with a parent node and one or more child nodes, include assigning a rank number to each of the nodes; upon detecting a connectivity failure of one of the nodes to its parent node, searching for a new parent node based at least in part on the rank numbers assigned to the nodes; and upon identifying the new parent node within a first predetermined time period, reconnecting said one of the nodes to the network by associating it with the new parent node.

### CROSS-REFERENCE TO RELATED APPLICATION

This application claims priority to and the benefit of U.S. Provisional Application No. 62/933,627 filed on Nov. 11, 2019, the entire disclosure of which is hereby incorporated by reference.

### TECHNICAL FIELD

The present invention relates generally to tree-based distance-vector routing protocols, and in various embodiments more specifically to approaches for fast connectivity recovery in such protocols.

### BACKGROUND

Recent developments in Internet and mobile communication technologies have enabled diverse multimedia services, which may be delivered almost instantaneously over vast distances. The proliferation of compact portable electronic devices such as notebook computers, mobile phones and tablets have necessitated deployment of such services, which tend to be very data-intensive, over wireless networks.

One commonly used wireless network has a tree-based structure. This network architecture is often deployed in device networks organized or governed by controllers. For example, tree-based wireless networks are often used when a controller controls a group of network members (or “nodes”); each group member will be reachable via a path across the wireless tree, enabling a point-to-multipoint communication (P2MP) (such as from the controller to some or all of the nodes) and multipoint-to-point communication (MP2P) (such as from some or all of the nodes to the controller). Common applications include controlled lighting systems, city-wide automatic meter-reading systems, and other municipal and commercial device networks.

To forward network traffic (e.g., packets) from a source node to one or more destination node(s) in the wireless network, various routing approaches may be used. For example, link-state routing protocols require every node to construct a map of connectivity to the network such that each node can independently calculate the best logical path from it to every possible destination node in the network. A collection of the best paths then forms a routing table for each node to use. Another routing approach involves a distance-vector routing algorithm that allows each node to share its routing table with its neighbors. Generally, distance-vector routing protocols assign weights to each link in the network and computes a “distance” to a destination by summing the weights along each possible path. Distance-vector routing protocols require each node to maintain the distance from itself to each possible destination and the neighbor through which to reach that destination. Whenever the network topology changes, each node in distance-vector routing protocols transmits new distance vectors to each of its neighbors, thereby allowing each neighbor to recalculate its routing table.

One advantage of distance-vector routing protocols is their smaller bandwidth overhead. This is particularly important in wireless mesh networks where hundreds or thousands of nodes are included and the available bandwidth is too small to run the link state routing protocols. But the distance-vector routing protocols have their own deficiencies. For example, the recovery time after a link (or connectivity) failure between two nodes may be relatively long; and the longer the recovery time is, the longer other network activities are halted (due to the large bandwidth being consumed by the recovery process). Typically, the long recovery time results from a routing loop created by a node that chooses another next-hop neighbor to connect with after the node loses connectivity to its neighbor that serves as the next hop towards a destination. For example, referring to FIG. 1A, assuming that after the tree network 100 is built, node B loses its connectivity to its parent node A; node B may then search for a new parent node to re-establish the connectivity to the tree network. Generally, node B may receive offers from all its neighboring nodes (e.g., nodes D, E and G). But because node B knows that nodes D and E are child nodes, node B will not accept their offers. Node B, however, may not know that node G is a child node of node D and may thus accept node G to be its new parent node; this then creates a routing loop 102 as depicted.

Various approaches have been proposed to avoid creation of a routing loop. For example, the routing protocol for low-power and lossy networks (RPL) allows node B to dismiss its entire subtree; each node in the subtree can subsequently choose a new parent node. As shown in FIG. 1B, node B, upon losing the connectivity to node A, dismisses its subtree including nodes D, E and G. Node E may then choose node C as its new parent node; and subsequently, nodes B, D and/or G may choose node E as their new parent node. While this approach may avoid creation of a routing loop in the network, dismissing the entire subtree prevents the nodes in the subtree from communicating to the gateway for a long time. In addition, when the wireless network includes hundreds of nodes, dismissing a subtree with many nodes may result in a very long recovery time.

Another approach for avoiding a routing loop in a tree network involves the use of a “path vector”—i.e., each node, when making an offer to its neighboring node, includes a description of the route it utilizes to reach the root node of the tree. For example, referring again to FIG. 1A, when making an offer to node B, node G may specify its route to node A as A-B-D-G. Thus, when node B receives the offer from node G with the description, it can recognize that node G cannot be its new parent node as this would create a routing loop. While this approach may decrease the likelihood of creating a routing loop, it cannot guarantee that the tree can recover from the connectivity failure. For example, referring again to FIG. 1B, assuming the only way to recover from the connectivity failure between nodes B and A is to have node E choose node C as its new parent node, the path-vector approach cannot provide such a solution. Moreover, the path-vector approach cannot guarantee that no routing loops will be created. For example, referring to FIG. 1C, assuming the links from node B to node A and from node C to node A both fail (this may be possible due to a wireless interference near node A), when the path-vector approach is implemented, node B may choose node C as its new parent node and node C may choose node E as its parent new node; as a result, a routing loop 104 is created.

Accordingly, there is a need for approaches that can facilitate prompt recovery from a connectivity failure in a tree-based distance-vector routing protocol while avoiding creation of a routing loop and avoiding dismissing the entire subtree of the node (and thereby losing its connectivity to the network).

### SUMMARY

The present invention relates to approaches for promptly recovering from a connectivity failure in a tree-based distance-vector routing protocol by assigning a rank number to each node in the network. In various embodiments, the rank number is assigned based on a number of intermediate nodes (or “hops”) traversed by a packet transmitted from the corresponding node en route to the root node using the distance-vector routing protocol. For example, a node having a smaller number of hops to the root node may have a smaller rank number than a node having a larger number of hops to the root node. When a node in the network loses connectivity to its parent node, the node may search for a new parent node that has a rank number smaller than its own. If the new parent node is found immediately (e.g., within the transmission time of 3 beacon messages), the node may associate itself with the new parent node to reconnect to the tree network. If, however, the new parent node is not identified immediately, the node may “freeze” the nodes in its subtree by broadcasting a message to its child nodes, which then broadcast the same freezing message to their child nodes and so on until the freezing message propagates down the entire subtree. A “frozen” node, as the term is used herein, can neither offer to be a parent node of another node nor accept any new node as its child node.

Once the subtree is frozen, the node losing connectivity to its parent node may perform a second search for the new parent node that has a smaller rank number than the node. If the new parent node is found within a predetermined time period (e.g., 10 seconds or 20 seconds), the node may associate itself with the new parent node so as to reconnect to the network; subsequently, the node may transmit an updated beacon message to its child nodes to unfreeze the subtree. If, however, the new parent node cannot be identified within the predetermined time period, the node may increase its rank number to infinity and transmit this information to its child nodes to cause dismissal of the child nodes. Once dismissed, the child nodes may proceed with the same search(es) performed by their previous parent node—i.e., performing (i) the search immediately after being dismissed and, if necessary, (ii) the second search within the predetermined time period in order to reconnect to the network. Again, if a new parent node cannot be identified in both searches within the predetermined time periods, the child nodes may dismiss the child nodes associated therewith.

Accordingly, various embodiments herein do not dismiss the entire subtree immediately after a node loses its connectivity to the parent node in the network. Rather, only the child nodes of the node that loses connectivity may be dismissed after a new parent node cannot be identified, for example, in two rounds of searches. In addition, because the node losing connectivity only searches for a new parent node that has a smaller rank number than its own, the node cannot choose any of the child nodes in its subtree to be the new parent node; this thereby avoids creation of a routing loop in the network. Further, because all child nodes in the subtree of the node that loses connectivity may be frozen during the second search, no child nodes in the subtree can offer to be the parent node or accept the node as their new child node. This may further ensure that no routing loops are created in the network.

Accordingly, in one aspect, the invention pertains to a method of recovering a connectivity failure in a network including multiple cells each (i) supporting communication among multiple transceiver nodes, (ii) being capable of receiving and transmitting a packet and (iii) being associated with a parent node and one or more child node. In various embodiments, the method includes (a) assigning a rank number to each of the nodes; (b) upon detecting a connectivity failure of one of the nodes to its parent node, searching for a new parent node based at least in part on the rank numbers assigned to the nodes; and (c) upon identifying the new parent node within the first predetermined time period (e.g., a transmission time of three beacon messages), reconnecting the node to the network by associating it with the new parent node. In one implementation, the rank number is assigned based at least in part on a number of intermediate nodes traversed by the packet transmitted from the node en route to a root node in the network using a distance-vector routing protocol. In addition, the new parent node may have a rank number smaller than that of the node.

In various embodiments, the method further includes, upon determining that the new parent node is not identified within the first predetermined time period, transmitting a message from the node to the child node(s) associated therewith so as to freeze activities thereof. In addition, the method may further include, thereafter, searching for the new parent node for the second predetermined time period (e.g., between 10 seconds and 20 seconds). In one embodiment, the method further includes, upon identifying the new parent node within the second predetermined time period, (i) reconnecting the node to the network by associating it with the new parent node and/or (ii) updating the rank number associated with the node based at least in part on the rank number associated with the new parent node. The method may further include transmitting an update message from the node to the child node(s) associated therewith so as to unfreeze the activities thereof.

In some embodiments, the method further includes, upon determining that the new parent node is not identified within the second predetermined time period, (i) increasing the rank number associated with the node and (ii) transmitting an update message from the node to the child node(s) associated therewith so as to disconnect the child node(s) therefrom. Additionally, the rank number associated with the node may be increased to infinity.

In another aspect, the invention relates to a router for recovering a connectivity failure in a network. In various embodiments, the router includes an assignment module configured to assign a rank number to the router; a search module configured to detect a connectivity failure of the router to its parent node and thereupon to search for a new parent node within the first predetermined time period (e.g., a transmission time of three beacon messages) and based at least in part on the rank number assigned to the router; and a connection module configured to detect identification of the new parent node by the search module and to responsively associate the router with the new parent node so as to reconnect the router to the network. In one implementation, the rank number is assigned based on a number of intermediate nodes traversed by a packet transmitted from the router en route to a root node in the network using a distance-vector routing protocol. In addition, the new parent node may have a rank number smaller than that of the router.

The connection module may be further configured to detect failure of the search module to identify the new parent node and to responsively transmit a message from the router to one or more child nodes associated therewith so as to freeze activities thereof. The search module may be further configured to search for the new parent node for the second predetermined time period (e.g., between 10 seconds and 20 seconds) after the activities of the child node(s) are frozen. Additionally, the connection module may be further configured to detect identification of the new parent node within the second predetermined time period and to responsively (i) associate the router with the new parent node so as to reconnect the router to the network and/or (ii) cause the assigning module to update the rank number associated with the router based at least in part on the rank number associated with the new parent node. In some embodiments, the connection module is further configured to transmit an update message to the child node(s) associated so as to unfreeze the activities thereof.

In addition, the connection module may be further configured to detect failure to identify the new parent node within the second predetermined time period and to responsively (i) increase the rank number associated with the router and (ii) transmit an update message to the child node(s) so as to disconnect the child node(s) from the router. In one embodiment, the rank number associated with the router is increased to infinity.

Another aspect of the invention relates to a network system for recovering a connectivity failure in a network having multiple cells each (i) supporting communication among multiple transceiver nodes, (ii) and being capable of receiving and transmitting a packet and (iii) being associated with a parent node and one or more child nodes. In various embodiments, the system includes memory for storing multiple rank numbers each associated with one of the nodes in the network; multiple network management systems each associated with one of the nodes and being configured to (i) detect a connectivity failure of the system-associated node, (ii) search for a new parent node based at least in part on the rank numbers assigned to the nodes in the network, and (iii) upon identifying the new parent node within the first predetermined time period (e.g., a transmission time of three beacon messages), associate the system-associated node to the new parent node. In one implementation, the rank number is assigned based on a number of intermediate nodes traversed by the packet transmitted from the node that has the connectivity failure en route to a root node in the network using a distance-vector routing protocol. The new parent node may have a rank number smaller than that of the node having the connectivity failure.

The network management system may be further configured to determine that the new parent node is not identified within the first predetermined time period and to thereupon cause transmission of a message from the system-associated node to the child node(s) associated therewith so as to freeze activities thereof. In addition, the network management system may be further configured to search for the new parent node of the system-associated node for the second predetermined time period (e.g., between 10 seconds and 20 seconds) after the activities of the child node(s) are frozen. In some embodiments, the network management system is further configured to, upon identifying the new parent node within the second predetermined time period, (i) associate the system-associated node with the new parent node and/or (ii) update the rank number associated with the system-associated node based at least in part on the rank number associated with the new parent node. The network management system may be further configured to cause transmission of a message from the system-associated node to the child node(s) associated therewith so as to unfreeze the activities thereof.

In addition, the network management system may be further configured to, upon determining that the new parent node is not identified within the second predetermined time period, (i) increase the rank number of the system-associated node and (ii) cause transmission of an update message from the system-associated node to the child node(s) associated therewith so as to disconnect the child node(s) therefrom. In addition, the rank number associated with the system-associated node may be increased to infinity.

Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIGS. 1A-1C depict various conventional approaches for recovering from a connectivity failure in a tree-based distance-vector routing protocol;

FIG. 2 conceptually illustrates an exemplary tree-based wireless network having multiple network nodes in accordance with various embodiments;

FIG. 3 depicts a rank number associated with each node in a tree-based wireless network in accordance with various embodiments;

FIG. 4A depicts an exemplary connectivity failure in a tree-based wireless network in accordance with various embodiments;

FIG. 4B depicts an exemplary recovered tree-based wireless network after a connectivity failure in accordance with various embodiments; and

FIG. 5 is a flow chart illustrating an exemplary approach for promptly recovering from a connectivity failure in a tree-based distance-vector routing protocol in accordance with various embodiments.

### DETAILED DESCRIPTION

FIG. 2 conceptually illustrates an exemplary tree-based wireless network 200 comprising multiple network nodes 202, each including one parent node and one child node, for multicast routing of messages such as group packets across the network 200 in accordance herewith. For example, the parent node contained in node 204 may transmit a packet to the child nodes contained in nodes 206-210 and the child nodes contained in node 206 may receive the packet from the parent node contained in node 204. Each group packet may include a payload (e.g., a data packet) and routing information (such as target bit identifier vectors, target multicast group IDs, etc.) as described in PCT Publication No. WO 2020/095114, the entire contents of which are incorporated herein by reference.

In one embodiment, each network node 202 is a member of a transceiver “cell,” i.e., a discrete geographic region having fixed-location transceivers on, for example, lighting poles. A transceiver cell typically includes a “parent” node (e.g., the parent node contained in node 204) and one or more child nodes (e.g., the child nodes contained in nodes 206-210). In addition, each of the parent and child nodes may include one transceiver. The parent node is the “owner” of the cell node(s); a child node may be associated with only one parent node at a time. In one embodiment, the child nodes connect to their parent nodes via a “wireless tree branch.” The child node(s) in a cell are within the radio transmission range of the parent node and vice versa. Typically, the parent node and its child nodes are within a one-hop distance from each other. In each cell, a data packet can be delivered in a “downlinked” manner—i.e., from the parent node to its child node(s) (e.g., using broadcasting to all child nodes, multicasting to a selected subset of the child nodes, or unicasting to a specific child node) and/or in an “uplinked” manner—i.e., from a child node to its associated parent node using, for example, unicasting. If the data packet received by the child node does not originate from its associated parent node, the child node may discard the data packet. Similarly, if the data packet received by the parent node does not originate from one of its associated child nodes, the parent node may discard the data packet.

In various embodiments, each node acts as both a parent node and a child node. The parent node is an entity contained in a node that acts as a cell parent; and the other cell members are child nodes of the parent node located one hop away from the parent node. Similarly, the child node is an entity contained in a node and is a cell member “owned” by a parent in another node (e.g., one-hop distance away that acts as the parent).

The tree-based wireless network 200 may be constructed dynamically using one or more conventional protocols and algorithms. In one embodiment, the network 200 is constructed as a spanning tree that interconnects each network node via a unique path to the tree root node. The same path may connect the tree root node to a network node. In some embodiments, the network 200 is constructed as multiple spanning trees with appropriate identifiers per tree; each tree (and thereby its associated identifier) supports a unique path between the tree root node and a network node on that tree. Thus, a downlink data packet that “originates” from the tree root node (or a network management system) may traverse a path across the tree that includes a collection of the network nodes wirelessly interconnected from the parent node of one network node to a child node within the parent's cell (i.e., one hop away). The destination network node can be reached via multiple hops. For a given tree, the path from the root node to the target node is always the same; in other words, the path acts as a “virtual circuit” for a data packet to be delivered from the root node to a target node. The virtual circuit may maintain the in-order delivery of packets, but does not guarantee that all delivered packets will reach the destination. Similarly, an uplink message may be delivered from a node to the root node via traversing a path therebetween. For example, assuming that nodes X, Y, and Z are along the path from the node originating the message to the tree root node, the uplink message may propagate along the wireless branches—i.e., from the originating child node (e.g., a child contained within node X) to its associated parent node (e.g., the parent contained within node Y), then internally propagate from the receiving parent node to the child node contained within the same node (e.g., node Y), then propagate further up to the parent node (e.g., contained within node Z) associated with the child node within node Y, and so on.

In various embodiments, each node contains two radio transceivers: one used by the parent within the node to send and/or receive data packets from the associated child node(s) and the other used by a child node within the node to send and/or receive data packets from the associated parent in another node. In addition, the tree structure may enable (i) each network node to deliver an uplink message directed to the tree root node (using, e.g., MP2P) via a path determined by the tree structure, and (ii) the root node to deliver a downlink message to a selected node (using, e.g., P2MP) via a path determined by the tree structure.

In addition, a collection of network nodes that have the same capability (e.g., equipped with a specific type of streetlight controller) may form a group. Each network node may be a member of (and thereby support) one or more groups. For example, a node may be a member of a citywide sensor group and a member of a group corresponding to a specific type of street lighting controller. The group members may be distributed across the tree structure in any fashion. For example, the group members may be concentrated in a geographical area (e.g., light controllers distributed in a specific neighborhood) or may be distributed citywide (e.g., air-quality sensors distributed across a city). In addition, the geographical location of one group may or may not overlap with that of another group. The tree-based network 200 can (but need not necessarily) be optimized for a certain group delivery. In one embodiment, the tree-based network 200 is constructed with various optimization rules without considering the possible group distributions.

In one embodiment, the wireless tree network 200 further includes a network management system (NMS) 212 to control one or more gateways that act as tree root nodes to the tree-based network. In addition, the NMS 212 may generate a message (e.g., a group packet) to the tree root(s) which then transmits the message to a specific network node or to a group of network nodes. In addition, the NMS 212 may be equipped with memory having a database to store information associated with the tree root nodes, network nodes and groups reachable via the corresponding tree roots. In some embodiments, each node 202 in the network 200 includes an individual NMS 214 having one or more modules for performing various functions (such as a rank-number-assignment module 216 for assigning a rank number to each node in the network and/or increasing the rank number to infinity, a search module 218 for searching for a new parent node, and a connection module 220 for associating the node to the new parent node and/or broadcasting a message to its child node(s) to cause “freezing” thereof, etc.) as further described below. In addition, the NMS 214 may be equipped with memory having a database to store information (e.g., the rank number) of the node 202 with which the NMS 214 is associated and the parent node and child nodes associated with the node 202.

The NMS 212/214 may include or consist essentially of a computing device, e.g., a server, which executes various program modules to perform methods in accordance with embodiments of the present invention. In addition, the memory may include or consist essentially of one or more volatile or non-volatile storage devices, e.g., random-access memory (RAM) devices such as DRAM, SRAM, etc., read-only memory (ROM) devices, magnetic disks, optical disks, flash memory devices, and/or other solid-state memory devices to store information associated with the tree root nodes and network nodes.

In some embodiments, each node, when or after being associated with the tree network, is assigned with a rank number. In one embodiment, the rank number is assigned based on a number of nodes (or “hops”) traversed by a packet transmitted from the node en route to the root node using a distance-vector routing protocol. For example, referring to FIG. 3, nodes 304, 306, which are the child nodes of a root node 302 (and thereby directly communicate with the root node 302) may be assigned with a rank number of 1. In addition, because nodes 308, 310 (which are the child nodes of node 304) and node 312 (which is the child node of node 306) require two hops to reach the root node 302, they may be assigned with a rank number of 2. The rank numbers may be stored in the databases associated with the nodes.

In various embodiments, after a node, v, loses its connectivity to its parent node, the node does not immediately dismiss its entire subtree. Rather, node v may first search for a new parent node that has a smaller rank number than node v (i.e., having fewer hops to the root node than node v). If such a new parent node is identified immediately, the searching node v can associate itself with the new parent node to reconnect to the network; the recovery process is then considered complete. Optionally, node v may update its rank number based on the rank number of the newly associated parent node. For example, if the rank number of the newly associated parent node is n, the rank number of node v after association is n+1. In addition, node v may transmit the updated rank number to its child nodes so that they can update their own rank numbers accordingly. As used herein, the term “immediately” refers to a relatively short amount of time, such as a time interval for transmitting 3 beacon messages (or, in some embodiments, 5 beacon messages). If, however, the new parent node having a smaller rank number than the searching node cannot be identified immediately, the searching node v may “freeze” its entire subtree and thereby prevent nodes in the frozen subtree from accepting new child nodes. In one embodiment, the searching node v freezes its subtree by periodically broadcasting a freeze message to its child node(s); each child node, upon receiving the message, changes its status to frozen such that it can neither offer to be a parent node nor accept a new child node. In addition, the child nodes may periodically broadcast the same beacon message to their own child nodes indicating their frozen status, which then causes the receiving child nodes to freeze as well; this message propagates “down the tree” until all nodes in the subtree of node v are frozen.

In some embodiments, after freezing its subtree, node v performs a second search for the new parent node that has a smaller rank number than node v. In one embodiment, node v is given a predetermined time interval (e.g., 10 seconds or, in some embodiments, 20 seconds) to perform the second search. The predetermined time interval for the second search may be longer than that for the first search as the second search may require node v to scan multiple channels and/or identify beacon messages from the potential new parent node. If the new parent node is identified within the predetermined time interval, node v may associate itself with the new parent node to regain connectivity to the tree network. Subsequently, node v may transmit an updated beacon message to its child nodes to unfreeze the entire subtree. Again, node v may optionally update its rank number based on the rank number of the newly associated parent node and then transmit the updated information to its child nodes for updating their rank numbers accordingly. If, however, the new parent node cannot be identified within the predetermined time interval, node v may increase its rank number to infinity and broadcast this information to its child nodes via an updated beacon message. In some embodiments, node v stops transmitting the beacon messages after a few (e.g., 5 or 10) messages have been sent.

In one embodiment, the child nodes, after receiving the updated message and/or after they stop receiving the message from node v, determine that node v can no longer serve as their parent node (i.e., the child nodes are now dismissed). Each child node may then proceed with the same searching procedure that node v performed to find a new parent node—i.e., each child node may perform the first (or immediate) search (and the second search if no parent node is identified in the first search) for a new parent node that has a smaller rank number than the child node as described above. Again, if the child node finds the new parent node immediately (e.g., within a transmission time of 3 beacon messages), it does not freeze the subtree and the connectivity recovery is considered complete after the child node is associated with its new parent node. If, however, the new parent node cannot be identified immediately in the first search, the child node may freeze its subtree and subsequently perform the second search. Again, if the new parent node can be identified in the second search within the predetermined time interval (e.g., 10 seconds or 20 seconds), the child node may associate itself with the new parent node. If, however, the new parent node cannot be identified in the second search within the predetermined time interval, the child node may increase its rank number to infinity and transmit this information to its child nodes to dismiss them, which then can perform the first search (and the second search if necessary) for a new parent node.

Accordingly, various embodiments herein do not require the node that loses connectivity to its parent node to dismiss its entire subtree immediately for recovery. Rather, only the child nodes of the node losing connectivity may be dismissed if the new parent node cannot be identified in two rounds of searches. In addition, because the node (e.g., node v) losing connectivity to its parent node may search only for a new parent node with a smaller rank number, the searching node cannot choose any of the child nodes in its subtree to be the new parent node; this thereby avoids creation of a routing loop in the network. Further, because all child nodes in the subtree of the node (e.g., node v) that loses connectivity are frozen, no child nodes in the subtree can offer to be the parent node of node v. As a result, node v cannot receive any offers from the child nodes in its subtree; this further ensures that no routing loops are created in the network.

FIG. 4A depicts an exemplary connectivity failure in a tree-based network 400 where both nodes B and C lose connectivity to their parent node A. Assuming neither node B nor node C can immediately find a new parent node having a smaller rank number than their own, they may freeze their associated subtrees 402, 404 and perform the second search for the new parent node. Assuming that the new parent node cannot be identified within the predetermined time (e.g., 10 seconds) in the second search, both nodes B and C may increase their rank numbers to infinity and dismiss their associated child nodes D, E, F. Thereafter, nodes D, E (which are the child nodes of node B) and F (which is the child node of node C) may search for new parent nodes in the same manner as nodes B and C. Referring to FIG. 4B, assuming that node F identifies and chooses node A to be its new parent node, upon associating with node A, node F may unfreeze its subtree (which is empty in FIGS. 4A and 4B) and optionally update its rank number based on the rank number of node A. Subsequently, node C may choose node F as its new parent node and optionally update its rank number; and nodes B and E may choose node C as their new parent node and, again, optionally update their rank numbers based on the new tree network 410.

FIG. 5 illustrates an exemplary approach 500 for promptly recovering from a connectivity failure in a tree-based distance-vector routing protocol in accordance herewith. In a first step 502, a rank number is assigned to each node in the network; the assigned rank number is stored in a database associated with the corresponding node. In one embodiment, the rank number is assigned based on a number of intermediate nodes (or hops) traversed by a packet transmitted from the corresponding node en route to the root node using the distance-vector routing protocol. In a second step 504, when a node detects a connectivity failure to its parent node, the node may search for a new parent node based on the rank numbers assigned to the nodes in the network. For example, the new parent node may have a rank number smaller than the node that lost connectivity. If the new parent node is identified immediately (e.g., within the transmission time of 3 beacon messages or, in some embodiments, 5 beacon messages), the node may associate itself with the new parent node so as to regain connectivity to the network (step 506). In addition, the node may optionally update its rank number based on the rank number of the newly associated parent node and then transmit this information to its child nodes to update their ranks numbers accordingly.

If, however, the new parent node cannot be identified immediately, the node may freeze its subtree (step 508). For example, the node may broadcast a “freeze” message to its child nodes, which then change their status to frozen and broadcast the same message to their child nodes. This message may propagate down the tree until all nodes in the subtree are frozen. Once the subtree is frozen, the node losing connectivity to its parent may perform a second search for a new parent node (step 510). If a new parent node is identified within a predetermined time period (e.g., 10 seconds or 20 seconds), the node may associate itself with the new parent node and transmit an updated beacon message to its child nodes to unfreeze the subtree (step 512). Again, the node may then optionally update its rank information based on the rank number of the newly associated parent node and transmit the updated information to its child nodes, enabling them to update their rank number accordingly. If, however, the new parent node cannot be identified within the predetermined time period, the node may increase its rank number to infinity and transmit this information to its child nodes to cause dismissal thereof (step 514). Thereafter, the newly dismissed nodes may perform steps 504-514 to reconnect to a new parent node or dismiss their associated child nodes.

It should be noted that the approaches described above for assigning a rank number to a node in the tree network are exemplary only; any suitable approach may be used and all are thus within the scope of the invention. In addition, the approaches described herein for promptly recovering from a connectivity failure in the tree-based distance-vector routing protocol can be implemented in any wireless network that has an underlying logical tree-based structure. Further, these approaches do not require the tree to be static. If the network is dynamic, the tree structure may occasionally change; the approaches described herein can automatically adapt to the new network topology.

The NMS 212/214 described herein may include one or more modules (e.g., a rank-number-assignment module 216, a search module 218, a connection module 220, etc.) implemented in hardware, software, or a combination of both for performing the functions described above (e.g., steps in FIG. 5). For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80×86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method of recovering a connectivity failure in a network comprising a plurality of cells each (i) supporting communication among a plurality of transceiver nodes, (ii) being capable of receiving and transmitting a packet and (iii) being associated with a parent node and at least one child node, the method comprising:
(a) assigning a rank number to each of the nodes;
(b) upon detecting a connectivity failure of one of the nodes to its parent node, searching for a new parent node based at least in part on the rank numbers assigned to the nodes; and
(c) upon identifying the new parent node within a first predetermined time period, reconnecting said one of the nodes to the network by associating it with the new parent node.

2. The method of claim 1, wherein the rank number is assigned based at least in part on a number of intermediate nodes traversed by the packet transmitted from said one of the nodes en route to a root node in the network using a distance-vector routing protocol.

3. The method of claim 2, wherein the new parent node has a rank number smaller than that of said one of the nodes.

4. The method of claim 1, wherein the first predetermined time period is a transmission time of three beacon messages.

5. The method of claim 1, further comprising, upon determining that the new parent node is not identified within the first predetermined time period, transmitting a message from said one of the nodes to the at least one child node associated therewith so as to freeze activities thereof.

6. The method of claim 5, further comprising, thereafter, searching for the new parent node for a second predetermined time period.

7. The method of claim 6, wherein the second predetermined time period is between 10 seconds and 20 seconds.

8. The method of claim 6, further comprising, upon identifying the new parent node within the second predetermined time period, (i) reconnecting said one of the nodes to the network by associating it with the new parent node and/or (ii) updating the rank number associated with said one of the nodes based at least in part on the rank number associated with the new parent node.

9. The method of claim 8, further comprising transmitting an update message from said one of the nodes to the at least one child node associated therewith so as to unfreeze the activities thereof.

10. The method of claim 8, further comprising, upon determining that the new parent node is not identified within the second predetermined time period, (i) increasing the rank number associated with said one of the nodes and (ii) transmitting an update message from said one of the nodes to the at least one child node associated therewith so as to disconnect the at least one child node from said one of the nodes.

11. The method of claim 10, wherein the rank number associated with said one of the nodes is increased to infinity.

12. A router for recovering a connectivity failure in a network, the router comprising:
an assignment module configured to assign a rank number to the router;
a search module configured to detect a connectivity failure of the router to its parent node and thereupon to search for a new parent node within a first predetermined time period and based at least in part on the rank number assigned to the router; and
a connection module configured to detect identification of the new parent node by the search module and to responsively associate the router with the new parent node so as to reconnect the router to the network.

13. The router of claim 12, wherein the rank number is assigned based on a number of intermediate nodes traversed by a packet transmitted from the router en route to a root node in the network using a distance-vector routing protocol.

14. The router of claim 13, wherein the new parent node has a rank number smaller than that of the router.

15. The router of claim 12, wherein the first predetermined time period is a transmission time of three beacon messages.

16. The router of claim 12, wherein the connection module is further configured to detect failure of the search module to identify the new parent node and to responsively transmit a message from the router to at least one child node associated therewith so as to freeze activities thereof.

17. The router of claim 16, wherein the search module is further configured to search for the new parent node for a second predetermined time period after the activities of the at least one child node are frozen.

18. The router of claim 17, wherein the second predetermined time period is between 10 seconds and 20 seconds.

19. The router of claim 17, wherein the connection module is further configured to detect identification of the new parent node within the second predetermined time period and to responsively (i) associate the router with the new parent node so as to reconnect the router to the network and/or (ii) cause the assigning module to update the rank number associated with the router based at least in part on the rank number associated with the new parent node.

20. The router of claim 19, wherein the connection module is further configured to transmit an update message to the at least one child node associated so as to unfreeze the activities thereof.

21. The router of claim 19, wherein the connection module is further configured to detect failure to identify the new parent node within the second predetermined time period and to responsively (i) increase the rank number associated with the router and (ii) transmit an update message to the at least one child node so as to disconnect the at least one child node from the router.

22. The router of claim 21, wherein the rank number associated with the router is increased to infinity.
